(19) United States
(12) Patent Application Publication
(10) Pub. No.: US 2009/0175142 A1
(43) Pub. Date: Jul. 9, 2009

(54) METHOD AND SYSTEM OF RECORDING DATA ON A STORAGE MEDIUM

(75) Inventors: Ping-Tsai Tsai, Kaohsiung City (TW); Pin-Chou Liu, Taipei Hsien (TW); Sung-Yang Wu, Hsinchu City (TW); Chih-Ching Yu, Hsinchu City (TW); Ya-Fang Nien, Hsinchu City (TW); Hsin-Chuan Lai, Taipei City (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: MEDIATEK INC., Hsin-Chu (TW)

(21) Appl. No.: 11/969,930

(22) Filed: Jan. 7, 2008

(51) Int. Cl. G11B 5/09

(52) U.S. Cl. 369/47.15

(57) ABSTRACT

A method of recording data on a storage medium is provided. A first recording indicator is written on the storage medium to indicate a first state of a data recording thereon. A second recording indicator is written on the storage medium to indicate a second state of the data recording thereon. A recording status of the data recording is determined accordingly in accordance with the first and second indicators.

### BACKGROUND OF THE INVENTION

2. Field of the Invention

The invention relates to data recording, and more particularly to a method and system for recording data on an optical recordable media.

2. Description of the Related Art

When recording data, accidental loss of data due to power failure or other event may occur. Thus, a device of data recovery is necessary to recover recorded data. Conventionally, a recovery mark is set in a disk when data is recorded, such that a recording system can recognize the recovery mark. When an abnormal interrupt is detected, the recording process is repeated and the recorded data is recovered. Recovery marks for each data recording are generally written at the same location on a disk. Repeatedly writing recovery marks at the same location causes rapid damage to the location of the mark. Thus, the disk may become useless due to this slight damage.

Thus, a method and system of recording data on a storage medium is desirable, increasing the lifetime of a disk and enhancing the failure recovery capability of a recovery mark.

### BRIEF SUMMARY OF THE INVENTION

Methods of recording data on an optical recordable media are provided. An exemplary embodiment of a method of recording data comprises the following. A first recording indicator is written on the storage medium to indicate a first state of a data recording thereon. A second recording indicator is written on the storage medium to indicate a second state of the data recording thereon. A recording status of the data recording is determined according to the first and second indicators.

Systems of recording data on an optical recordable medium are provided. An exemplary embodiment of a system of recording data comprises a reading and writing unit, a determination unit, and an address assignation unit. The reading and writing unit writes a first recording indicator on the storage medium to indicate a first state of a data recording thereon and a second recording indicator on the storage medium to indicate a second state of the data recording thereon, and read the first and second recording indicators. The determination unit determines a recording status of the data recording according to the first and second indicators read and transmitted by the reading and writing unit. The determination unit determines the data recording is complete when the first and second indicators satisfy a predetermined condition. The address assignation unit assigns a first address located in the storage medium to the first indicator and a second address located in the storage medium to the second indicator.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 is a schematic view of a mark group area, illustrating initial, start recording, end recording, and power failure states;

FIG. 2 is a schematic view of a mark group area, illustrating a count exceeding a predetermined value, the written count which cannot be read, or the read count which is not equal to the previously written count;

FIG. 3 is a schematic view of a mark group area, illustrating an indicator comprising a count or a predefined pattern to represent the start and end of a data recording;

FIG. 4 is a schematic view of a mark group area, illustrating a second count as a function of a first count;

FIG. 5 is a schematic view of a mark group area, illustrating fixed and randomly assigned recording indicator addresses;

FIG. 6 is a schematic view of a mark group area, illustrating fixed addresses of recording indicators;

FIG. 7 is a schematic view of a mark group area, illustrating deriving an address of recording indicator from writing times of the recording indicators on the storage medium;

FIG. 8 is a schematic view of a mark group area;

FIG. 9 is a schematic view of a mark group area, illustrating reusing recording indicators;

FIG. 10 is a flowchart of an embodiment of a method of recording data on an optical recordable media;

FIG. 11 is a flowchart of an embodiment of a method of recording data, determining whether a data recovery is required; and

FIG. 12 is a schematic view of an embodiment of a system of recording data on an optical recordable media.

### DETAILED DESCRIPTION OF THE INVENTION

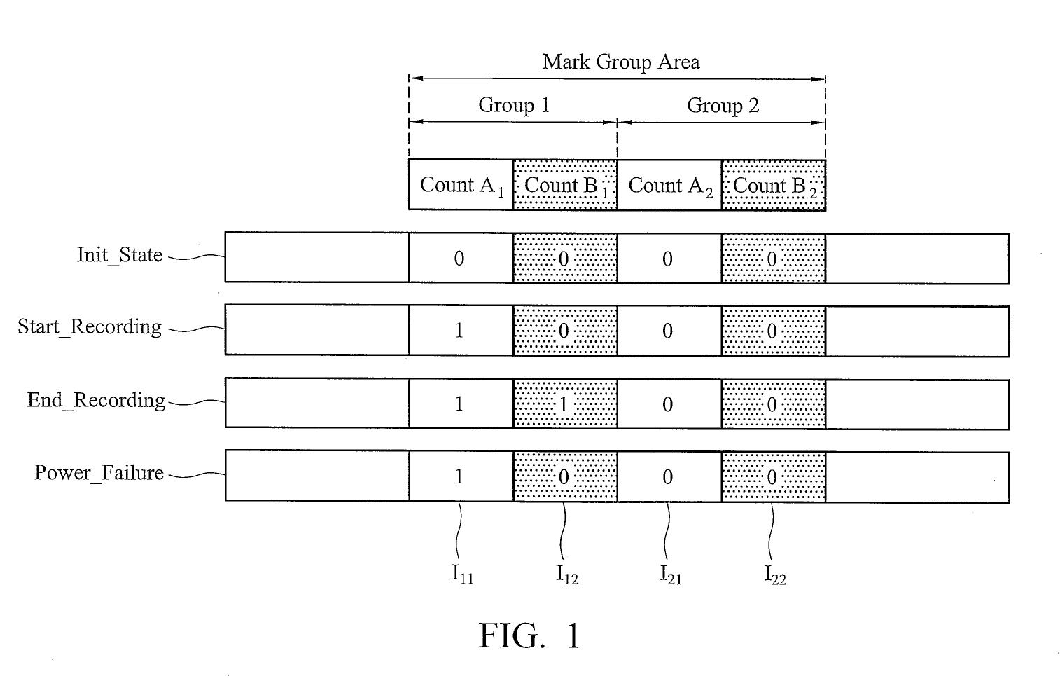

Several exemplary embodiments of the invention are described with reference to FIGS. 1 through 12, which generally relate to recording data on a storage medium. It is to be understood that the following disclosure provides various different embodiments as examples for implementing different features of the invention. Specific examples of components and arrangements are described in the following to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various described embodiments and/or configurations.

The invention discloses methods and systems of recording data on a storage medium. The storage medium can be, but is not limited to, an optical recordable medium.

The method and system of recording data define a mark group area, providing, but not limited to, at least two counts to represent an initial state, a start recording state, an end recording state, and an abnormal interrupt state (power failure, for example).

As shown in the embodiment of FIG. 1, the mark group area comprises group 1 and group 2. The group 1 comprises two recording indicators I₁₁ and I₁₂. The recording indicators I₁₁ and I₁₂ are assigned counts A₁ and B₁, respectively. Group 2 also comprises two recording indicators I₂₁ and I₂₂. The recording indicators I₂₁ and I₂₂ are assigned counts A₂ and B₂, respectively. When in a initial state where a data recording on a storage medium (an optical disk, for example) has not been executed, counts A₁ and B₁ equal to 0 as the first data bar in FIG. 1. When in a start recording state where a data recording on the storage medium begins as the second data bar in FIG. 1, count A₁ is added by 1 and count B₁ remains. When in an end recording state where the data recording on the storage medium terminates as the third data bar in FIG. 1, count A₁ remains and count B₁ is added by 1. Thus, when a data recording on the storage medium begins and an abnormal interrupt then occurs, count A₁ is not equal to count B₁ as the fourth data bar in FIG. 1.

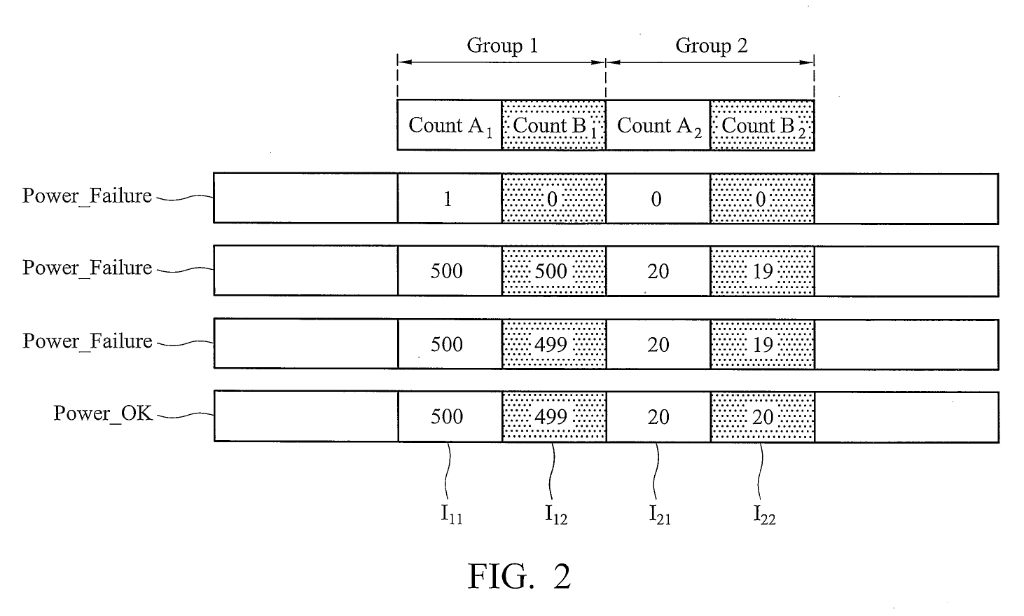

Further, another two counts of a new group are utilized to write and read recovery marks when the writing times of two counts of a group exceed a predetermined value, avoiding damage on the storage medium due to repeated writing operation of recovery marks on the same location. The new group with its two counts can also be utilized when the written count cannot be read, or the read count is not equal to the previously written count. Hence, as shown in FIG. 2, the first data bar represents a power failure condition, in which the group 2 has not been used and an abnormal interrupt occurs when a data recording is executed, such that count A₁ of the group 1 is not equal to count B₁ thereof. The second data bar represents a power failure condition, in which the writing times of count A₁ and count B₁ have reached a predetermined value of 500, group 2 is utilized to write and read recovery marks. Next, an abnormal interrupt occurs when a data recording is executed, such that count A₂ of the group 2 is not equal to count B₂ thereof. Further, the power failure condition is determined according to whether the writing times of count A₁ is equal to that of count B₁ of the last initialed group.

The third data bar in FIG. 2 also represents a power failure condition, in which count A₁ not equal to count B₁ may be due to an abnormal interrupt or that count B₁ cannot be written, the group 2 is utilized to write and read recovery marks. Next, when an abnormal interrupt occurs, count A₂ is not equal to count B₂. The fourth data bar represents a successful recording condition, in which count A₁ not equaling to count B₁ may be due to an abnormal interrupt or that count B₁ cannot be written, the group 2 is utilized to write and read recovery marks. Next, count A₂ is equal to count B₂, indicating no abnormal interrupts occur and the data recording is successfully completed.

As described, the mark group area comprises multiple mark groups. Each mark group is composed of one or more error correction code (ECC) blocks. A recording indicator is defined in each ECC block and a count is assigned to a recording indicator. Additionally, as shown in FIGS. 1 and 2, the embodiment applies two counts as a group and one count as a start indicator and the other as an end indicator, but is not limited to this. An indicator comprising a count can also be defined as a mark group.

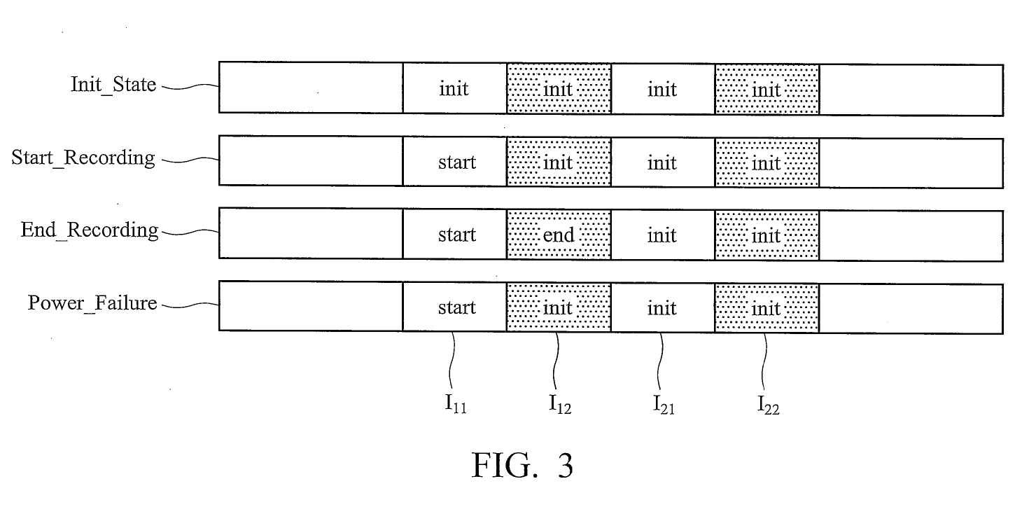

Further, an indicator may comprise a count or a predefined pattern to represent the state of a data recording such as the start and end thereof. As shown in the first data bar of FIG. 3, for example, when a data recording on a storage medium has not been executed, all defined recording indicators (I₁₁, I₁₂, I₂₁, I₂₂) are filled with the string “init”. When a data recording begins, recording indicator I₁₁ is filled with the string “start” as represented by the second data bar and, when completed, recording indicator I₁₂ is filled with the string “end” to replace the string “init” as represented by the third data bar. When the data recording is interrupted and recording indicator I₁₂ is not filled with the string “end”, a data recording system can verify that the interrupt is an abnormal interrupt.

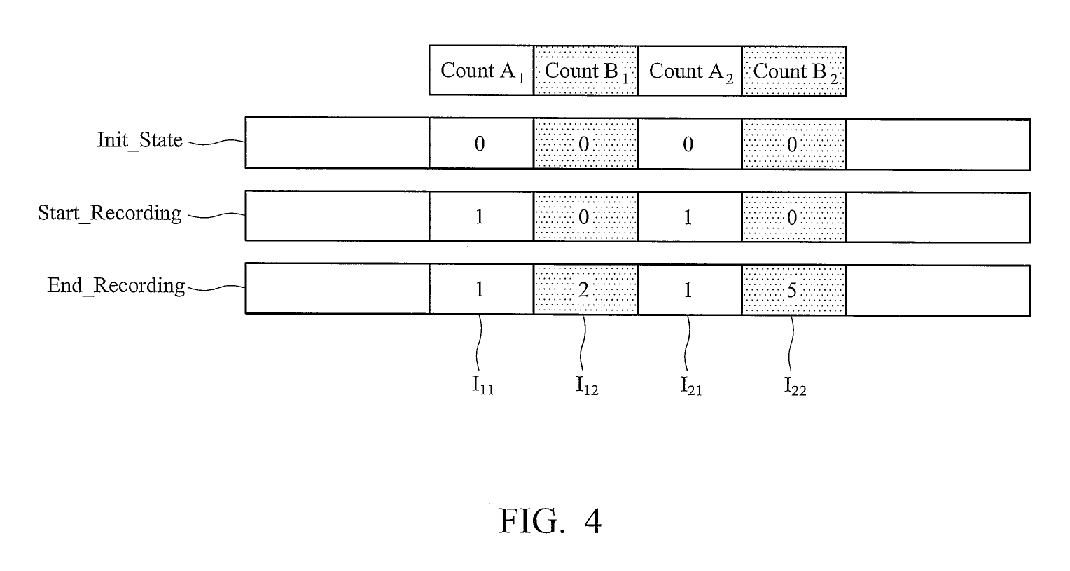

Further, when each indicator is assigned a count, a second count can be a function of a first count. As shown by recording indicators I₁₁ and I₁₂ in FIG. 4, (count B₁)=(count A₁)+1. Thus, when a data recording on storage medium (an optical disk, for example) has not been executed, for example, counts A₁ and B₁ equal to 0 as represented by the first data bar of FIG. 4. When a data recording on the storage medium begins, count A₁ is added by 1 and count B₁ remains as represented by the second data bar of FIG. 4. When the data recording on the storage medium terminates, count A₁ remains and count B₁ is added by 2 (count B₂=1+1=2) as represented by the third data bar of FIG. 4. In another example, as shown by recording indicators I₂₁ and I₂₂ in FIG. 4, (count B₂)=(count A₂)×5. Thus, when a data recording on a storage medium (an optical disk, for example) has not been executed, for example, counts A₂ and B₂ equal to 0 as shown in the first data bar. When a data recording on the storage medium begins, count A₂ is added by 1 and count B₁ remains as shown in the second data bar. When the data recording on the storage medium terminates, count A₂ remains and count B₅ is added by 5 (count B₂=1×5=5) as represented by the third data bar of FIG. 4.

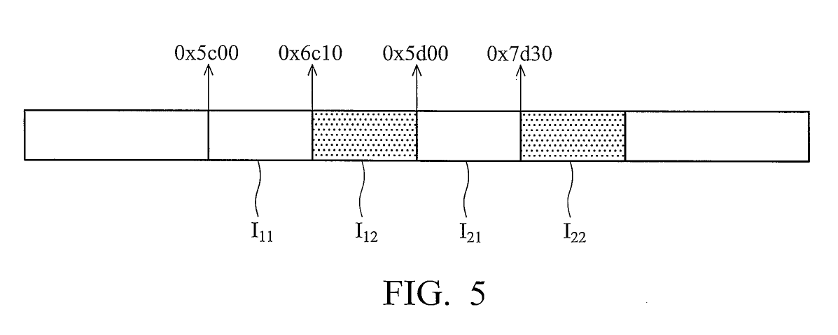

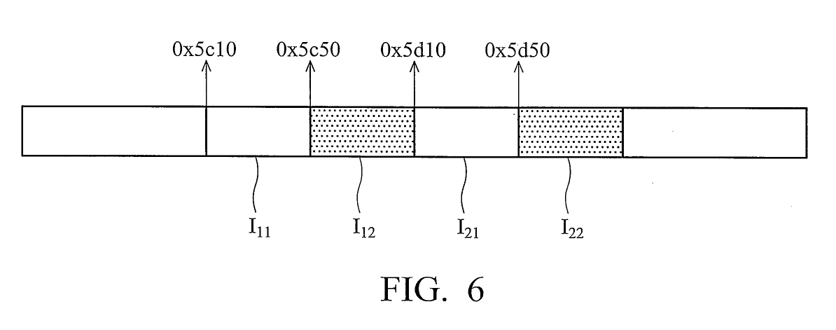

Further, each ECC block comprising a recording indicator is assigned an address of a storage medium to be recorded. An address of a recording indicator can be fixed and that of another can be randomly assigned or both the addresses are fixed. As shown in FIG. 5, recording indicators I₁₁ and I₂₁ are assigned fixed addresses “0x5c00” and “0x5d00”, respectively, while recording indicators I₁₂ and I₂₂ are randomly assigned addresses “0x6c10” and “0x7d30”, respectively. As shown in FIG. 6, recording indicators I₁₁ and I₁₂ are assigned fixed addresses “0x5c10” and “0x5c50”, respectively, while recording indicators I₂₁ and I₂₂ are assigned fixed addresses “0x5d10” and “0x5d50”, respectively.

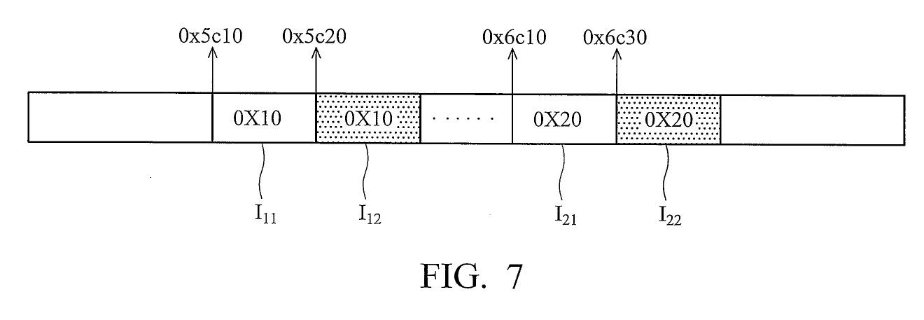

Further, an address of a recording indicator can be derived from writing times of a data recording on the storage medium. An initial address of a recording indicator may be fixed. When the writing times of a data recording process on a storage medium are equal to 5, an address of a subsequent recording indicator is equal to the initial address plus 5. As shown in FIG. 7, recording indicator I₁₁ is assigned fixed address “0x5c10”, while recording indicators I₁₂ is assigned an address “0x5c20” due to the writing time equal to 16. Similarly, recording indicator I₂₁ is assigned an address “0x6c10”, while recording indicator I₂₂ is assigned an address “0x6c30” due to the writing time being equal to 32.

Further, an address of a recording indicator can be derived from failure conditions of the data recording on the storage medium. Failure conditions may be recorded in a lookup table. When a data recording is executed, the address of each recording indicator can be determined based on the lookup table, which is not further described herein.

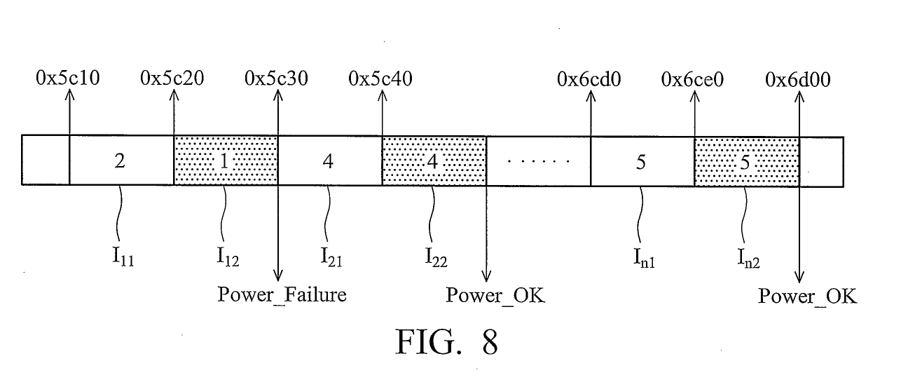

Addresses of each recording indicator can be determined within a predefined range. As shown in FIG. 8, the predefined range is, for example, “0x5c10”˜“0x6d00”. When a data recording on a storage medium begins, addresses of recording indicators can be randomly determined within the predefined range to record recovery marks. In another case, an address of a first recording indicator is determined from the start address within the predefined range. When a count of the first recording indicator, for example, has achieved the predetermined value or the first recording indicator is useless, a subsequent address of a second recording indicator is then determined to record recovery marks until the addresses within the predefined range are depleted. In another case, addresses of recording indicator are circularly determined within the predefined range. An address of a first recording indicator, for example, is first determined from the start address within the predefined range. When the first recording indicator has been written once or is useless, a subsequent address of a second recording indicator is determined to be written, and so forth. In another case, addresses of recording indicators are determined based on a predefined sequence within the predefined range. Addresses located at odd positions within the predefined range are first utilized and then the even positions. An address located at the first position, for example, is assigned to the first recording indicator, while an address located at the third position is assigned to the second recording indicator, and so forth.

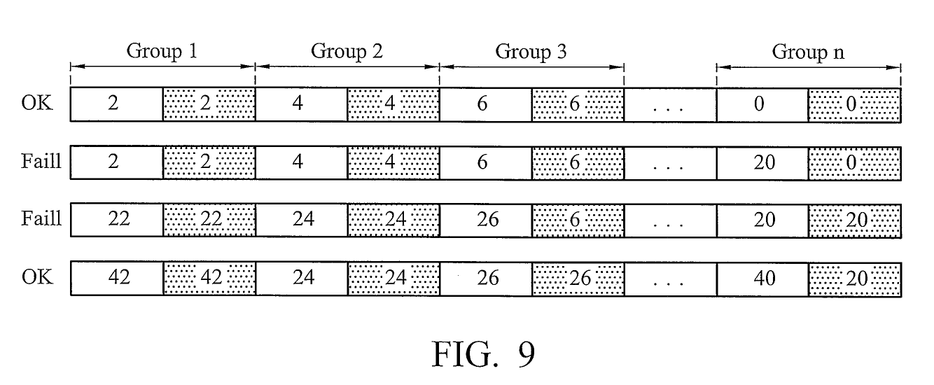

Another example is illustrated in FIG. 9, in which n groups are provided and each group comprises two counts. Each count of a group is sequentially added by two when a data recording begins and terminates, and the first group (Group 1) is reused when the last group (Group n) has been used. Additionally, each count of each group is initially filled with zero. Referring to FIG. 9, the first bar indicates a normal recording condition, in which three groups are used and sequentially added by 2. Each count of group 1 is filled with 2, each count of group 2 is filled with 4, while each count of group 3 is filled with 6. A maximum count of a group is located to determine whether the data recording is normal. The two counts of group 3 are identical so the data recording is normal. Referring to the second bar, the two counts of group n are different so the data recording is abnormal (power failure). Referring to the third bar, groups 1, 2, and 3 are reused and the two counts of group 3 are different, so the data recording is abnormal (power failure). Referring to the final bar, groups 1 is further reused and the two counts of group 1 are identical, so the data recording is normal. The two counts of group n are different since a power failure occurs or the right count cannot be written.

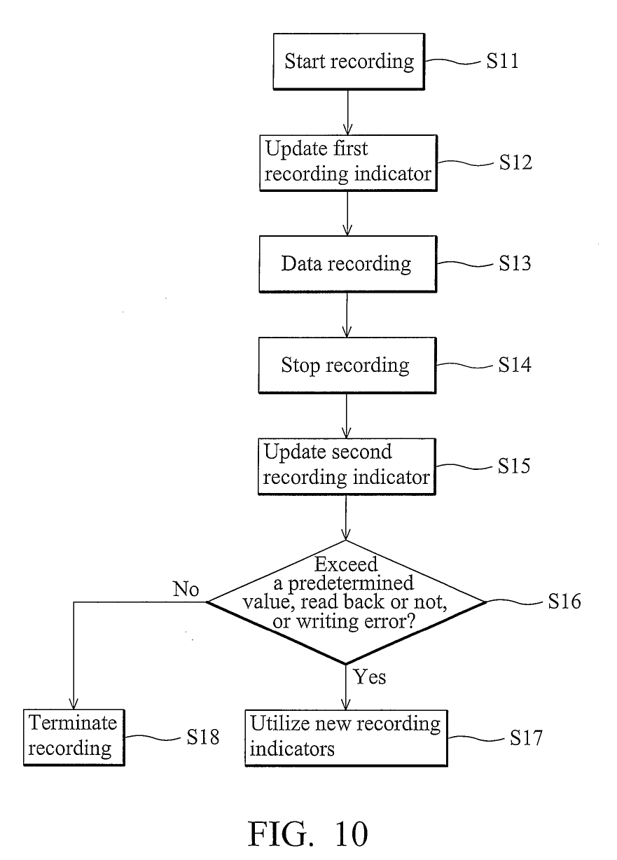

FIG. 10 is a flowchart of an embodiment of a method of recording data on an optical recordable media.

A first recording indicator and a second recording indicator are first defined. When a data recording process on a storage medium begins (step S11), the first recording indicator is updated (step S12). The first recording indicator may comprise a count to be added by numbers. When the first recording indicator is updated, data recording is executed (step S13). When the data recording process terminates (step S14), the second recording indicator is updated (step S15). If each of the first and second recording indicators is assigned a count respectively, it is determined whether the value of each count exceeds a predetermined value, whether the written count value can be read back, or whether a writing error for each count occurs (step S16). If so, another two recording indicators are utilized to record recovery marks (step S17), and, if not, the data recording process terminates (step S18).

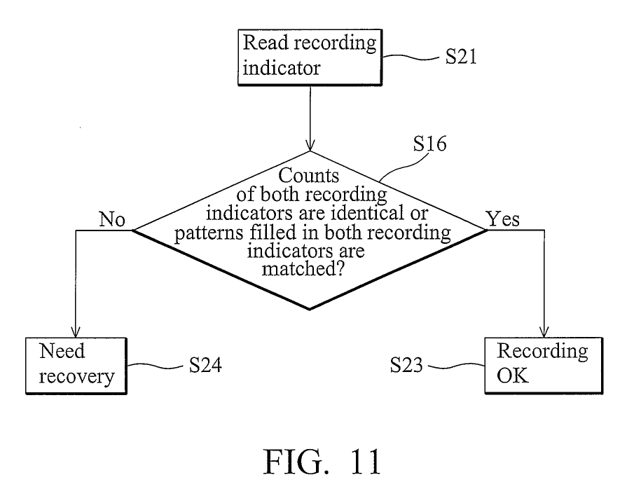

FIG. 11 is a flowchart of an embodiment of a method of recording data, determining whether a data recovery is required.

The first and second recording indicators are first read (step S21). It is determined whether the count of the first recording indicator is equal to that of the second recording indicator or the pattern in the first recording indicator matches that in the second recording indicator (step S22). If so, the data recording is correct (step S23), and, if not, a data recovery on the storage medium is required (step S24).

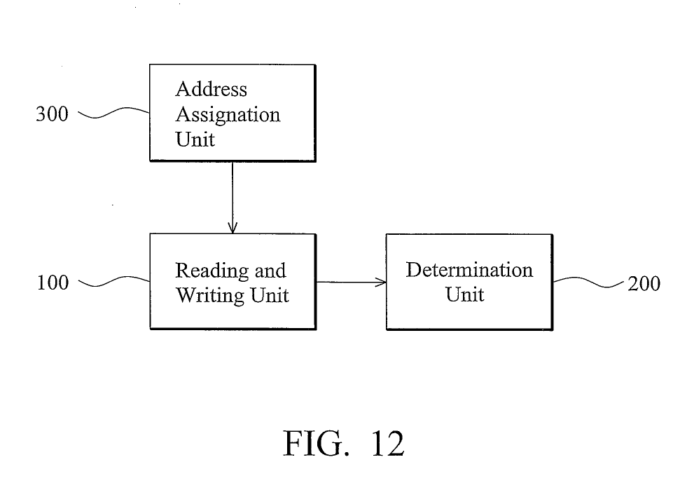

FIG. 12 is a schematic view of an embodiment of a system of recording data on an optical recordable media.

The recording system comprises a reading and writing unit 100, a determination unit 200, and an address assignation unit 300.

The reading and writing unit 100 writes a first recording indicator on the storage medium to indicate a first state of a data recording thereon and a second recording indicator on the storage medium to indicate a second state of the data recording thereon. The reading and writing unit 100 further read the first and second recording indicators. The determination unit 200 determines a recording status of the data recording in accordance with the first and second indicators read and transmitted by the reading and writing unit 100. The determination unit 200 determines the data recording is complete when the first and second indicators satisfy a predetermined condition.

The address assignation unit 300 assigns a first address located in the storage medium to the first indicator and a second address located in the storage medium to the second indicator. The second address may be derived from the first address, or from a writing number of the first indicator on the storage medium.

Additionally, the reading and writing unit 100 writes the first and second recording indicators of the subsequent mark group when values of the first and second indicators of the first mark group reach a corresponding writing value. The determination unit 200 determines a recording status of the data recording according to the first and second indicators of a last written mark group.

Additionally, the reading and writing unit 100 reads the first and second recording indicators. The determination unit 200 determines whether a count or a value of the first recording indicator is equal to that of the second recording indicator or a pattern in the first recording indicator matches that in the second recording indicator, if equal or matched, determines the data recording is correct, and, if unequal or unmatched, determines to perform a data recovery on the storage medium.

Methods and systems of the present disclosure, or certain aspects or portions of embodiments thereof, may take the form of program code (i.e., instructions) embodied in media, such as floppy diskettes, CD-ROMS, hard drives, firmware, or any other machine-readable storage medium, wherein, when the program code is loaded into and executed by a machine, such as a computer, the machine becomes an apparatus for practicing embodiments of the disclosure. The methods and apparatus of the present disclosure may also be embodied in the form of program code transmitted over some transmission medium, such as electrical wiring or cabling, through fiber optics, or via any other form of transmission, wherein, when the program code is received and loaded into and executed by a machine, such as a computer, the machine becomes an apparatus for practicing and embodiment of the disclosure. When implemented on a general-purpose processor, the program code combines with the processor to provide a unique apparatus that operates analogously to specific logic circuits.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method of recording data on a storage medium, comprising:
writing a first recording indicator on the storage medium to indicate a first state of a data recording thereon;
writing a second recording indicator on the storage medium to indicate a second state of the data recording thereon; and
determining a recording status of the data recording according to the first and second indicators.

2. The method of recording data on a storage medium as claimed in claim 1, wherein the first state is when the data recording begins, and the second state is when the data recording is completed.

3. The method of recording data on a storage medium as claimed in claim 1, determining a recording status of the data recording comprises determining the data recording is complete when the first and second indicators satisfy a predetermined condition.

4. The method of recording data on a storage medium as claimed in claim 3, further comprising if the first and second indicators do not satisfy a predetermined condition, performing a data recovery on the storage medium.

5. The method of recording data on a storage medium as claimed in claim 3, wherein the predetermined condition describes a value of the first indicator equal to that of the second recording indicator, a value of the first indicator and that of the second recording indicator satisfy a function of the first and second indicators, or a pattern represented by the first indicator matches that of the second indicator.

6. The method of recording data on a storage medium as claimed in claim 1, further comprising:
assigning a first address located in the storage medium to the first indicator;
and
assigning a second address located in the storage medium to the second indicator.

7. The method of recording data on a storage medium as claimed in claim 6, wherein the first and second addresses are fixed or randomly selected, or determined according to a predetermined sequence.

8. The method of recording data on a storage medium as claimed in claim 6, further comprising deriving the second address from the first address, or from a writing number of the first indicator on the storage medium.

9. The method of recording data on a storage medium as claimed in claim 6, wherein the first and second addresses are within a predefined range.

10. The method of recording data on a storage medium as claimed in claim 9, wherein the first and second addresses are circularly selected within the predefined range.

11. The method of recording data on a storage medium as claimed in claim 1, wherein the first and second indicators is comprised in a mark group and further comprising writing first and second recording indicators of a subsequent mark group to indicate the first and second states of the data recording respectively.

12. The method of recording data on a storage medium as claimed in claim 11, further comprising writing the first and second recording indicators of the subsequent mark group when values of the first and second indicators of the first mark group reach a corresponding writing value.

13. The method of recording data on a storage medium as claimed in claim 12, wherein a corresponding writing value for the indicators of the subsequent mark group is determined according to the corresponding writing value for the indicators of the mark group.

14. The method of recording data on a storage medium as claimed in claim 11, determining a recording status of the data recording further comprising determining the recording status of the data recording according to the first and second indicators of a last written mark group.

15. A system of recording data on a storage medium, comprising:
a reading and writing unit, writing a first recording indicator on the storage medium to indicate a first state of a data recording thereon and a second recording indicator on the storage medium to indicate a second state of the data recording thereon, and reading the first and second recording indicators; and
a determination unit, determining a recording status of the data recording according to the first and second indicators read and transmitted by the reading and writing unit.

16. The system of recording data on a storage medium as claimed in claim 15, wherein the first state is when the data recording begins, and the second state is when the data recording complete.

17. The system of recording data on a storage medium as claimed in claim 15, wherein the determination unit determines the data recording is complete when the first and second indicators satisfy a predetermined condition.

18. The system of recording data on a storage medium as claimed in claim 15, wherein if the first and second indicators do not satisfy a predetermined condition, the determination unit determines to perform a data recovery on the storage medium.

19. The system of recording data on a storage medium as claimed in claim 15, wherein the predetermined condition describes a value of the first indicator equal to that of the second recording indicator, a value of the first indicator and that of the second recording indicator satisfy a function of the first and second indicators, or a pattern represented by the first indicator matches that of the second indicator.

20. The system of recording data on a storage medium as claimed in claim 15, further comprising:
an address assigning unit, assigning a first address located in the storage medium to the first indicator and a second address located in the storage medium to the second indicator.

21. The system of recording data on a storage medium as claimed in claim 20, wherein the first and second addresses are fixed or randomly selected, or determined according to a predetermined sequence.

22. The system of recording data on a storage medium as claimed in claim 20, wherein the second address is derived from the first address or from a writing number of the first indicator on the storage medium.

23. The system of recording data on a storage medium as claimed in claim 15, wherein the first and second indicators is comprised in a mark group and the reading and writing unit writes first and second recording indicators of a subsequent mark group to indicate the first and second states of the data recording respectively, and reads the first and second recording indicators.

24. The system of recording data on a storage medium as claimed in claim 23, wherein the reading and writing unit writes the first and second recording indicators of the subsequent mark group when values of the first and second indicators of the first mark group reach a corresponding writing value.

25. The system of recording data on a storage medium as claimed in claim 23, the determination unit further determines the recording status of the data recording according to the first and second indicators of a last written mark group.
